(19) United States
(12) Patent Application Publication
(10) Pub. No.: US 2011/0210938 A1
(43) Pub. Date: Sep. 1, 2011

(54) Capacitance Offset Compensation for Electronic Device

(75) Inventors: Yu Kuang, Hsinchu City (TW); Tung-Ke Wu, Taipei City (TW); Shih-Tzung Chou, Zhudong Township (TW); Tsung-Lin Wu, Sanchong City (TW)

(73) Assignee: RAYDIUM SEMICONDUCTOR CORPORATION, Hsinchu (TW)

(21) Appl. No.: 13/032,747

(22) Filed: Feb. 23, 2011

(30) Foreign Application Priority Data
Feb. 26, 2010 (TW) 99105704

(51) Int. Cl. G06F 3/044

(52) U.S. Cl. 345/174

(57) ABSTRACT

An electronic device includes: a touch input device, a touch sensing circuit coupled to the touch input device and a capacitance offset compensation circuit. The capacitance offset compensation circuit includes: a first offset compensation capacitance array, coupled to a reference voltage or a driving signal in response to a control signal from the touch sensing circuit, coupled to one of a first coupling voltage and a second coupling voltage from the touch input device in response to the control signal. The first offset compensation capacitance array adjusts an output equivalent capacitance in response to the control signal, for compensating at least one of a GND parasitic capacitance and a cross coupling capacitance of the touch input device.

This application claims the benefit of Taiwan application Serial No. 99105704, filed Feb. 26, 2010, the subject matter of which is incorporated herein by reference.

### TECHNICAL FIELD

The disclosure relates in general to an electronic device for compensating capacitance offset.

### BACKGROUND

Currently, touch switch such as capacitive switch is already available. For the convenience of use, the touch panel or the display touch panel (having both display and touch functions), which accepts data/instruction from the user or user's click, is widely used in various electronic devices such as mobile phone. Thus, the user can directly input data/instruction or click on the touch panel or the display touch panel and such operation mode is convenient and friendly to the user. There are a variety of touch panels or display touch panels, such as capacitive touch panel or capacitive display touch panel.

When the user operates a capacitive touch panel, a capacitive display touch panel, or a capacitive switch, the capacitance of the capacitor under test thereof varies. Thus, the user's operation will be detected (sensed) if the capacitance of the capacitor under test and its variance can be detected. The capacitive touch panel detects the position of the touch point according to the capacitance variance of the sensing grid embedded in the touch panel.

FIG. 1 shows a conventional touch panel 10. Referring to FIG. 1. The touch panel 10 includes a plurality of X-direction wires X1˜Xm and a plurality of Y-direction wires Y1˜Yn, m and n are both positive integers being identical or different from each other. The X-direction wires and the Y-direction wires are formed in different layers. The X-direction wires and the Y-direction wires are intersected to form a sensing grid. A cross coupling capacitor, (such as the cross coupling capacitor 100a, 100b or 100c in FIG. 1) is formed at each of the intersection by the X-direction wire and Y-direction wire. Let FIG. 1 be taken for example, the touch panel 10 has m*n cross coupling capacitors in total.

When an object (such as a finger or a stylus) touches the touch panel 10, the coupling relationship between the object and the sensing grid will change capacitances of nearby cross coupling capacitors. A detection circuit can thus detect the location of the touch point according to the capacitance variance of the cross coupling capacitors.

The cross coupling capacitances may be different from each other or the GND parasitic capacitances of the wires may be different if wires of the touch panel are defective due to the problem of manufacturing process or have different shapes. The touch position may be misjudged.

Therefore, the disclosure discloses a capacitance offset compensation circuit for compensating the offset of the GND parasitic capacitance and/or the offset of the cross coupling capacitance.

### BRIEF SUMMARY

The disclosure is directed to an electronic device which compensates the offset of the GND parasitic capacitance and/or the offset of the cross coupling capacitance of a touch panel.

According to an example of the disclosure, an electronic device including a touch input device, a touch sensing circuit coupled to the touch input device, and a capacitance offset compensation circuit is provided. The capacitance offset compensation circuit includes a first selector, a second selector, and a first offset compensation capacitor array. The first selector selects one of a first coupling voltage and a second coupling voltage of the touch input device in response to a control signal from the touch sensing circuit. The second selector selects one of a driving signal and a reference voltage in response to the control signal. The offset compensation capacitor array, coupled to the first selector or the second selector, adjusts its own output equivalent capacitance in response to the control signal for compensating at least one of a GND parasitic capacitance and a cross coupling capacitance of the touch input device.

According to another example of the disclosure, an electronic device including a touch input device, a touch sensing circuit coupled to the touch input device, and a capacitance offset compensation circuit is provided. The capacitance offset compensation circuit includes a first selector, a second selector, a first offset compensation capacitor array, and a second offset compensation capacitor array. The first selector selects one of a first coupling voltage and a second coupling voltage of the touch input device in response to a control signal from the touch sensing circuit. The second selector selects one of the first coupling voltage and the second coupling voltage in response to the control signal. The first offset compensation capacitor array, coupled to the first selector and a driving signal, adjusts its own output equivalent capacitance in response to the control signal for compensating a cross coupling capacitance of the touch input device. The second offset compensation capacitor array, coupled to the second selector and a reference voltage, adjusts its own output equivalent capacitance in response to the control signal for compensating a GND parasitic capacitance of the touch input device.

According to yet another example of the disclosure, an electronic device including a touch input device, a touch sensing circuit coupled to the touch input device, and a capacitance offset compensation circuit is provided. The capacitance offset compensation circuit includes a first offset compensation capacitor array, coupled to a reference voltage or a driving signal in response to a control signal from the touch sensing circuit and coupled to one of a first coupling voltage and a second coupling voltage of the touch input device in response to the control signal. The first offset compensation capacitor array adjusts its own output equivalent capacitance in response to the control signal for compensating at least one of a GND parasitic capacitance and a cross coupling capacitance of the touch input device.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a conventional touch panel;

FIG. 2 shows an electronic device according to a first embodiment of the disclosure;

FIG. 3A shows an equivalent circuit diagram for compensating a GND parasitic capacitance according to the first embodiment of the disclosure;

FIG. 3B shows an equivalent circuit diagram for compensating a cross coupling capacitance according to the first embodiment of the disclosure; and

FIG. 4 shows an electronic device according to a second embodiment of the disclosure.

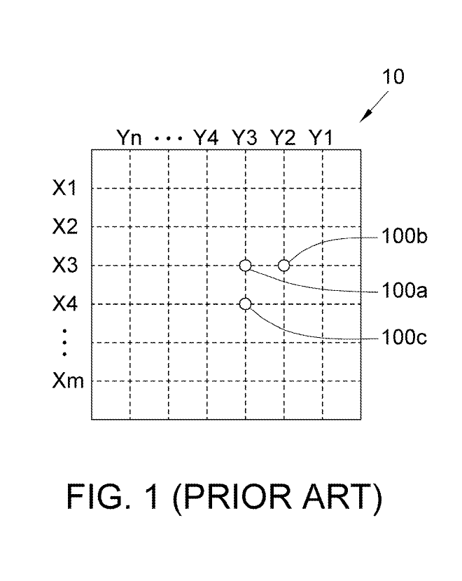

### DETAILED DESCRIPTION OF THE DISCLOSURE

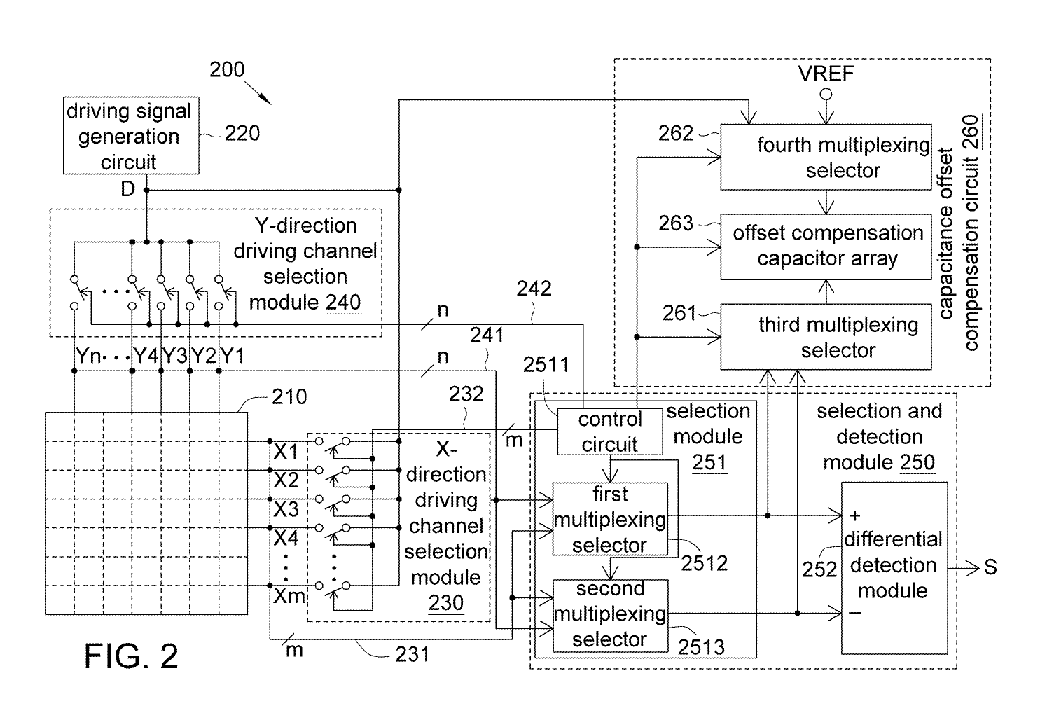

FIG. 2 shows an electronic device according to a first embodiment of the disclosure. As indicated in FIG. 2, the electronic device 200 includes a touch panel 210, a driving signal generation circuit 220, an X-direction driving channel selection module 230, a Y-direction driving channel selection module 240, a selection and detection module 250 and a capacitance offset compensation circuit 260. The X-direction driving channel selection module 230, the Y-direction driving channel selection module 240 and the selection and detection module 250 may be referred as a touch sensing circuit.

The driving signal generation circuit 220 generates a driving signal D to X-direction wires X1˜Xm and Y-direction wires Y1˜Yn. The driving signal D is for example but not limited to squared wave driving signal, triangular wave driving signal, cosine wave driving signal and the like.

The X-direction driving channel selection module 230 includes m switches each controlled by a respective control signal from the control circuit 2511. Each of the control signals is inputted to a respective switch via the signal line 232. The m switches respectively are coupled between the driving signal generation circuit 220 and a corresponding one of the X-direction wires X1˜Xm. The coupling voltages of the X-direction wires X1˜Xm are respectively inputted to the selection and detection module 250 via the signal line 231.

The Y-direction driving channel selection module 240 includes n switches each controlled by a respective control signal from the control circuit 2511. Each of the control signals is inputted to a respective switch via a signal line 242. The n switches are respectively coupled between the driving signal generation circuit 220 and a corresponding one of the Y-direction wires Y1˜Yn. The coupling voltages of the Y-direction wires Y1˜Yn are respectively inputted to the selection and detection module 250 via the signal line 241.

The selection and detection module 250 includes a selection module 251 and a differential detection module 252. The selection module 251 includes a control circuit 2511, a first multiplexing selector 2512 and a second multiplexing selector 2513. The capacitance offset compensation circuit 260 includes a third multiplexing selector 261, a fourth multiplexing selector 262 and an offset compensation capacitor array 263. The offset compensation capacitor array 263 includes a plurality of compensation capacitors.

After the touch panel 210 is manufactured, the touch panel 210 is measured. The GND parasitic capacitance of the direction wires as well as all cross coupling capacitances of the panel are recorded to determine whether capacitance offset occurs. The capacitances of the compensation capacitors are related to the respective offset of the GND parasitic capacitance of the direction wires as well as the respective offset of the cross coupling capacitances of the panel.

The principles of operation of the first embodiment are disclosed below. The control circuit 2511 sequentially scans (conducts) the switches. Suppose the user touches the intersection between the direction wires X2 and Y1. Under the control of the control circuit 2511, the corresponding switch is conducted so that the driving signal D is inputted to the Y-direction wire Y1. Moreover, the coupling voltages VY1X1 and VY1X2 are respectively coupled to the differential detection module 252 via the first multiplexing selector 2512 and the second multiplexing selector 2513. The coupling voltages VY1X1 and VY1X2 refer the coupling voltages respectively generated when the driving signal D is applied to the cross coupling capacitors CY1X1 and CY1x2. In the next timing sequence, the driving signal D is inputted to the Y-direction wire Y1; and the coupling voltages VY1X2 and VY1X3 are respectively coupled to the differential detection module 252 via the first multiplexing selector 2512 and the second multiplexing selector 2513. Ideally, that is without any capacitance offset, the differential detection module 252 detects VY1x2≠VY1X1 and VY1X2≠VY1X3. Thus, whether the user touches the intersection between the direction wires X2 and Y1 can be determined according to the output signal S of the differential detection module 252.

In detection of the touch position, the control circuit 2511 may input the driving signal D to the X-direction wires and direct the coupling voltage of the Y-direction wires to the differential detection module 252 via the first multiplexing selector 2512 and the second multiplexing selector 2513.

However, in actual application, the GND parasitic capacitances of the wires may be different from each other, and/or the cross coupling capacitances may be different from each other. The details of compensating the offset of the GND parasitic capacitance and/or the offset of the cross coupling capacitance with the capacitance offset compensation circuit 260 according to the first embodiment are disclosed below.

In compensating the capacitance offset, under the control of the control circuit 2511, the third multiplexing selector 261 connects the output signal of one of the first multiplexing selector 2512 and the second multiplexing selector 2513 to the offset compensation capacitor array 263; and the fourth multiplexing selector 262 inputs one of the reference voltage source VREF and the driving signal D to the offset compensation capacitor array 263. The control circuit 2511 selects a compensation capacitor from the offset compensation capacitor array 263.

(1) Compensation of the Offset of the GND Parasitic Capacitance:

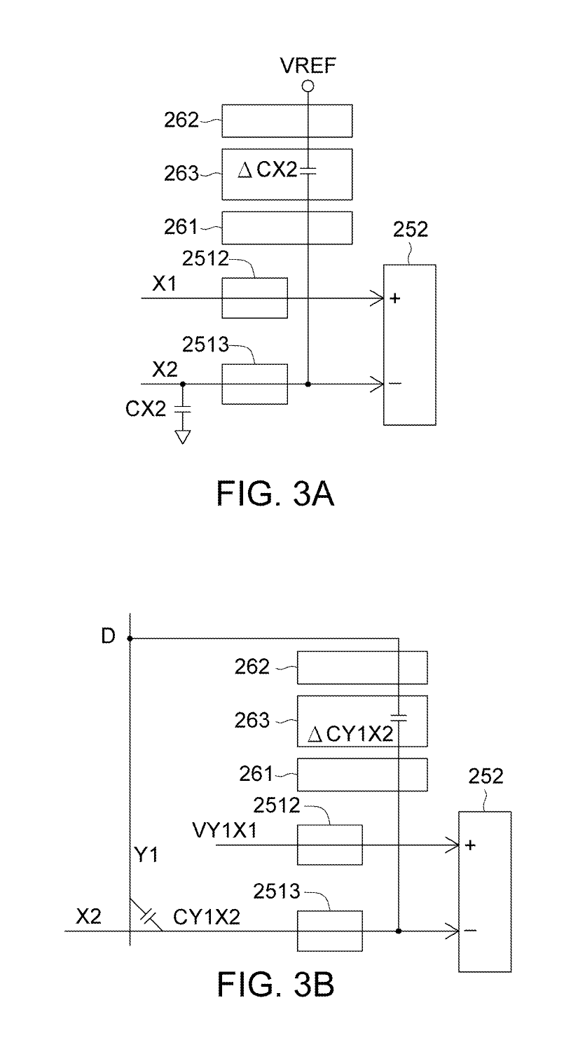

Suppose the GND parasitic capacitance of the X-direction wire X2 has offset. As disclosed above, when the differential detection module 252 compares the coupling voltage VY1X1 (the output signal of the first multiplexing selector 2512) with the coupling voltage VY1X2 (the output signal of the second multiplexing selector 2513), under the control of the control circuit 2511, the third multiplexing selector 261 connects the output signal of the second multiplexing selector 2513 to the offset compensation capacitor array 263; and the fourth multiplexing selector 262 inputs the reference voltage source VREF to the offset compensation capacitor array 263. The control circuit 2511 selects a compensation capacitor from the offset compensation capacitor array 263. The equivalent circuit is illustrated in FIG. 3A. In FIG. 3A, CX2 denotes the GND parasitic capacitance of the X-direction wire X2, and ΔCX2 denotes the compensation capacitance for the GND parasitic capacitance of the X-direction wire X2.

For example, the control circuit 2511 has a table which records whether the respective GND parasitic capacitance of the direction wires of the touch panel 210 has offset and its corresponding compensation capacitance. When the control circuit 2511 selects to input the coupling voltage on the direction wire with offset GND parasitic capacitance to the differential detection module 252, the control circuit 2511 compensates the offset by selecting a compensation capacitor.

(2) Compensation of the Offset of the Cross Coupling Capacitance:

Suppose offset occurs to the cross coupling capacitance CY1X2 between the X-direction wire X2 and the Y-direction wire Y1. As disclosed above, when the differential detection module 252 compares the coupling voltage VY1X1 (the output signal of the first multiplexing selector 2512) with the coupling voltage VY1X2 (the output signal of the second multiplexing selector 2513), under the control of the control circuit 2511, the third multiplexing selector 261 connects the output signal of the second multiplexing selector 2513 to the offset compensation capacitor array 263; the fourth multiplexing selector 262 inputs the driving signal D to the offset compensation capacitor array 263. The control circuit 2511 selects a compensation capacitor from the offset compensation capacitor array 263. The equivalent circuit is illustrated in FIG. 3B. In FIG. 3B, CY1X2 denotes the cross coupling capacitance between the X-direction wire X2 and the Y-direction wire, and ΔCX2Y1 denotes the compensation capacitance for the cross coupling capacitance CY1X2.

For example, the control circuit 2511 has another table which records whether the respective cross coupling capacitance of the touch panel 210 has offset and its corresponding compensation capacitance. When the control circuit 2511 selects to input the coupling voltage of the direction wires with offset cross coupling capacitance to the differential detection module 252, the control circuit 2511 will compensates the offset by selecting a compensation capacitor.

In the above example, the GND parasitic capacitance and the cross coupling capacitance can be compensated. That is, the compensation capacitors of the offset compensation capacitor array 263 can compensate the GND parasitic capacitance and the cross coupling capacitance. However, offset compensation can be performed to either the GND parasitic capacitance or the offset of the cross coupling capacitance at a time.

In other examples of the first embodiment of the disclosure, one of the GND parasitic capacitance and the cross coupling capacitance is compensated. That is, the compensation capacitors of the offset compensation capacitor array 263 are used for compensating one of the GND parasitic capacitance and the cross coupling capacitance.

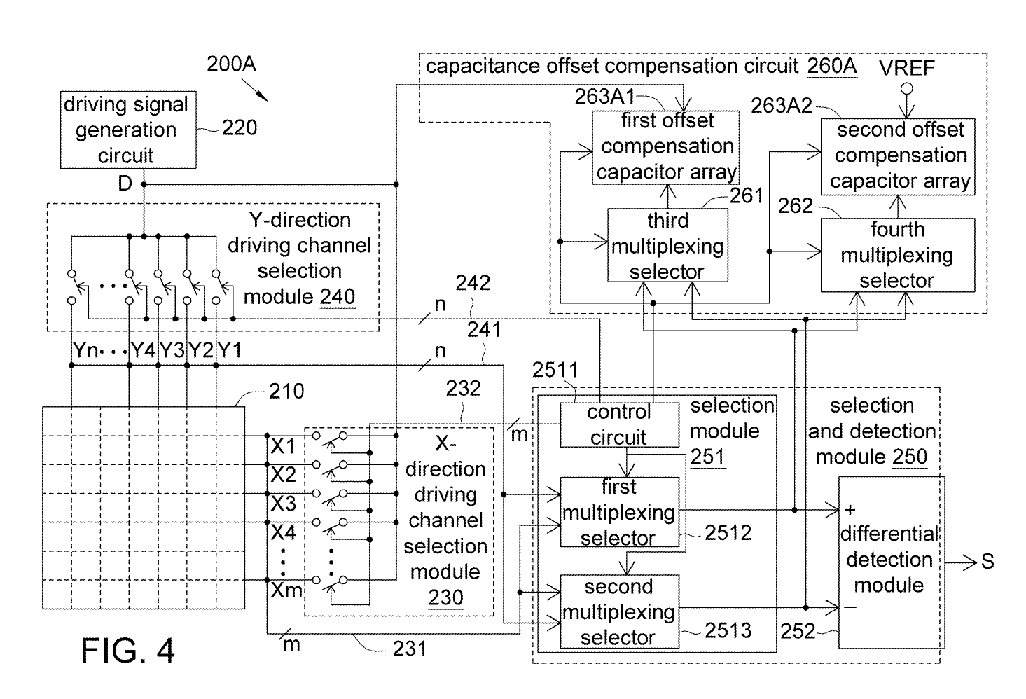

FIG. 4 shows an electronic device 200A according to a second embodiment of the disclosure. The second embodiment of the disclosure is similar to that of the first embodiment, and the similarities are not repeated here.

In the second embodiment of the disclosure, the capacitance offset compensation circuit 260A further includes a first offset compensation capacitor array 263A1 and a second offset compensation capacitor array 263A2. Each of the first offset compensation capacitor array 263A1 and the second offset compensation capacitor array 263A2 includes a plurality of compensation capacitors. The first offset compensation capacitor array 263A1 may compensate the cross coupling capacitances of the touch panel 210, and the second offset compensation capacitor array 263A2 may compensate the GND parasitic capacitance of the direction wires.

The principles of operation of the second embodiment are disclosed below. In compensating the capacitance offset, under the control of the control circuit 2511, the third multiplexing selector 261 connects the output signal of one of the first multiplexing selector 2512 and the second multiplexing selector 2513 to the first offset compensation capacitor array 263A1; and the fourth multiplexing selector 262 connects the output signal of one of the first multiplexing selector 2512 and the second multiplexing selector 2513 to the second offset compensation capacitor array 263A2. The first offset compensation capacitor array 263A1 receives the driving signal D, and the second offset compensation capacitor array 263A2 receives the reference voltage VREF. The control circuit 2511 selects a compensation capacitor from the first offset compensation capacitor array 263A1 and selects a compensation capacitor from the second offset compensation capacitor array 263A2. Thus, the GND parasitic capacitance and the cross coupling capacitance may be compensated at the same time or at different time according to the second embodiment of the disclosure.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. An electronic device, comprising:
a touch input device;
a touch sensing circuit coupled to the touch input device; and
a capacitance offset compensation circuit, comprising:
a first selector, selecting one of a first coupling voltage and a second coupling voltage of the touch input device in response to a control signal from the touch sensing circuit;
a second selector for selecting one of a driving signal and a reference voltage in response to the control signal; and
an offset compensation capacitor array coupled to the first selector or the second selector, for adjusting its own output equivalent capacitance in response to the control signal for compensating at least one of a GND parasitic capacitance and a cross coupling capacitance of the touch input device.

2. The electronic device according to claim 1, wherein, if the offset compensation capacitor array compensates the GND parasitic capacitance of a direction wire of the touch input device, the first selector selects the first coupling voltage outputted from the direction wire and outputs to the offset compensation capacitor array, and the second selector selects and outputs the reference voltage to the offset compensation capacitor array.

3. The electronic device according to claim 1, wherein, if the offset compensation capacitor array compensates the cross coupling capacitance of a direction wire of the touch input device, the first selector selects the first coupling voltage outputted from the direction wire and outputs to the offset compensation capacitor array, and the second selector selects and outputs the driving signal to the offset compensation capacitor array.

4. An electronic device, comprising:
a touch input device;
a touch sensing circuit coupled to the touch input device; and
a capacitance offset compensation circuit, comprising:
a first selector for selecting one of a first coupling voltage and a second coupling voltage of the touch input device in response to a control signal from the touch sensing circuit;
a second selector for selecting one of the first coupling voltage and the second coupling voltage in response to the control signal;
a first offset compensation capacitor array coupled to the first selector and a driving signal, for adjusting an output equivalent capacitance of the first offset compensation capacitor array in response to the control signal for compensating a cross coupling capacitance of the touch input device; and
a second offset compensation capacitor array coupled to the second selector and a reference voltage, for adjusting an output equivalent capacitance of the second offset compensation capacitor array in response to the control signal for compensating a GND parasitic capacitance of the touch input device.

5. An electronic device, comprising:
a touch input device;
a touch sensing circuit coupled to the touch input device; and
a capacitance offset compensation circuit, comprising:
a first offset compensation capacitor array coupled to a reference voltage or a driving signal in response to a control signal from the touch sensing circuit and coupled to one of a first coupling voltage and a second coupling voltage of the touch input device in response to the control signal, for adjusting an output equivalent capacitance of the first offset compensation capacitor array in response to the control signal for compensating at least one of a GND parasitic capacitance and a cross coupling capacitance of the touch input device.

6. The electronic device according to claim 5, wherein, the capacitance offset compensation circuit further comprising:
a first selector for conducting one of the first coupling voltage and the second coupling voltage to the first offset compensation capacitor array in response to the control signal; and
a second selector for conducting one of the reference voltage and the driving signal to the first offset compensation capacitor array in response to the control signal.

7. The electronic device according to claim 6, wherein, if the first offset compensation capacitor array compensates the GND parasitic capacitance of a direction wire of the touch input device, the first selector conducts the first coupling voltage outputted from the direction wire to the first offset compensation capacitor array, and the second selector conducts the reference voltage to the first offset compensation capacitor array.

8. The electronic device according to claim 6, wherein, if the first offset compensation capacitor array compensates the cross coupling capacitance of a direction wire of the touch input device, the first selector conducts the first coupling voltage outputted from the direction wire to the first offset compensation capacitor array, and the second selector conducts the driving signal to the first offset compensation capacitor array.

9. The electronic device according to claim 5, wherein,
the first offset compensation capacitor array is coupled to the driving signal for compensating the cross coupling capacitance of the touch input device;
the capacitance offset compensation circuit further comprising:
a second offset compensation capacitor array coupled to the reference voltage for compensating the GND parasitic capacitance of the touch input device;
a first selector for conducting one of the first coupling voltage and the second coupling voltage to the first offset compensation capacitor array in response to the control signal; and
a second selector for conducting one of the reference voltage and the driving signal to the second offset compensation capacitor array in response to the control signal.
